(19) United States
(12) Patent Application Publication
(10) Pub. No.: US 2011/0202769 A1
(43) Pub. Date: Aug. 18, 2011

(54) SYSTEM AND METHOD FOR DETECTING COPY OF SECURE MICRO

(75) Inventors: Han Seung KOO, Daejeon (KR); Young Ho JEONG, Daejeon (KR); Soon Choul KIM, Daejeon (KR)

(73) Assignee: Electronics and Telecommunications Research Institute, Daejeon (KR)

(21) Appl. No.: 12/944,451

(22) Filed: Nov. 11, 2010

(30) Foreign Application Priority Data
Feb. 12, 2010 (KR) 10-2010-0013115
Jun. 4, 2010 (KR) 10-2010-0052936

(51) Int. Cl. H04L 9/00; G06F 21/00

(52) U.S. Cl. 713/171; 726/32

(57) ABSTRACT

A Secure Micro (SM) copy detection system includes at least one Access Point (AP) that is connected to at least one host group including at least one SM, at least one Multiple-Services Operator (MSO) that is used to manage the at least one SM and includes the at least one AP, and a host information management server that is used to perform authentication of the at least one SM and that is independently connected to the at least one MSO.

### CROSS-REFERENCE TO RELATED APPLICATIONS

This application claims the benefit of Korean Patent Application No. 10-2010-0013115 and of Korean Patent Application No. 10-2010-0052936, respectively filed on Feb. 12, 2010 and Jun. 4, 2010, in the Korean Intellectual Property Office, the disclosures of which are incorporated herein by reference.

### BACKGROUND

1. Field of the Invention

The present invention relates to a system for detecting a copy of a Secure Micro (SM) in a Downloadable Conditional Access System (DCAS), and an SM copy detection method using the system.

2. Description of the Related Art

A Conditional Access System (CAS) on a cable network may determine, based on a subscriber authentication result, whether a service is viewed, and may enable only authenticated subscribers to receive a specific program, when service subscribers desire to view the specific program.

In an initial CAS, a cable card such as a Personal Computer Memory Card International Association (PCMCIA) card has been frequently used as a Conditional Access (CA) module separate from a receiver. However, when a service is actually operated, it is difficult to obtain a desired result due to an increase in price of cable cards, an increase in management costs, and sluggishness of a receiver retail market.

Currently, operators enable various CA software, such as an SM Client Image, to be downloaded in a subscriber's receiver using a conventional cable network, rather than a hardware-based CA module being separately installed in the subscriber's receiver. Accordingly, there is a demand for a DCAS technology that may provide a fee-based broadcasting service.

The DCAS may include a DCAS headend system used to manage downloading of SM Client Image information through mutual authentication, and a DCAS host that is a subscriber's host.

Content is frequently illicitly provided due to an unauthorized copy of an SM included in the DCAS host and thus, there is a desire to further strengthen security and authentication to prevent the unauthorized copy.

### SUMMARY

According to an aspect of the present invention, there is provided a Secure Micro (SM) copy detection system, including: at least one Access Point (AP) connected to at least one host group including at least one SM; at least one Multiple-Services Operator (MSO) to manage the at least one SM, the MSO including the at least one AP; and a host information management server to perform authentication of the at least one SM, the host information management server being independently connected to the at least one MSO.

According to another aspect of the present invention, there is provided an SM copy detection method, including: at least one AP connected to at least one host group including at least one SM; at least one MSO to manage the at least one SM, the MSO including the at least one AP; and a host information management server to perform authentication of the at least one SM, the host information management server being dependent on the at least one MSO.

According to still another aspect of the present invention, there is provided an SM copy detection system, including: at least one AP connected to at least one host group including at least one SM; at least one MSO to manage the at least one SM, the MSO including the at least one AP; a first host information management server to perform authentication of the at least one SM, the first host information management server being dependent on the at least one MSO; and a second host information management server to perform authentication of the at least one SM, the second host information management server being independently connected to the at least one MSO.

According to an aspect of the present invention, there is provided an SM copy detection method, including: receiving first identifier (ID) information from at least one SM, the first ID information regarding an ID of the at least one SM; transmitting, to a host information management server, the first ID information, second ID information regarding an ID of at least one AP, and version information of the at least one SM; receiving a result of a validity check of the at least one SM, the validity check being performed based on the first ID information, the second ID information, and the version information; and authenticating the at least one SM based on the received result.

According to another aspect of the present invention, there is provided an SM copy detection method, including: receiving, from at least one AP, first ID information regarding an ID of at least one SM, second ID information regarding an ID of the at least one AP, and version information of the at least one SM; first checking a validity of the at least one SM based on the first ID information and the second ID information; second checking the validity of the at least one SM based on state information of the at least one SM, the state information being received from the at least one AP; third checking the validity of the at least one SM based on the version information; and authenticating the at least one SM based on a result of at least one of the first checking, the second checking, and the third checking.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a Secure Micro (SM) copy detection system according to an embodiment of the present invention;

FIG. 2 is a block diagram illustrating a configuration of an SM copy detection system according to another embodiment of the present invention;

FIG. 3 is a block diagram illustrating a configuration of an SM copy detection system according to still another embodiment of the present invention;

FIG. 4 is a flowchart illustrating an SM copy detection method according to an embodiment of the present invention;

FIG. 5 is a flowchart illustrating an SM copy detection method using a host information management server according to an embodiment of the present invention; and

FIGS. 6A and 6B are flowcharts illustrating an SM copy detection method using a host information management server according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

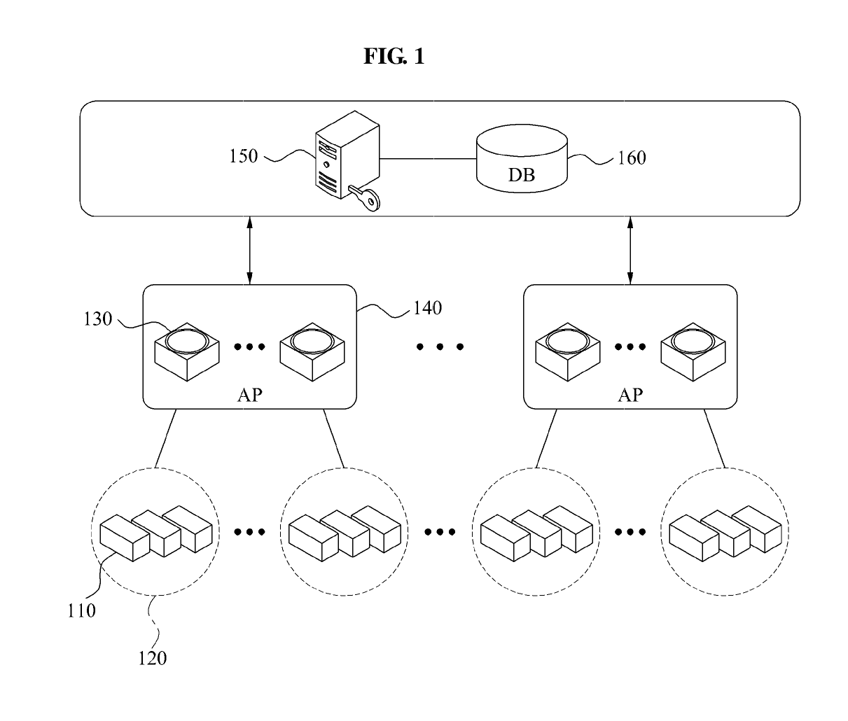

FIG. 1 is a block diagram illustrating a configuration of a Secure Micro (SM) copy detection system according to an embodiment of the present invention.

The SM copy detection system of FIG. 1 may perform authentication of an SM using a Downloadable Conditional Access System Host Information Management (DHIM) server that is independently connected to a Multiple-Services Operator (MSO) used to manage a plurality of SMs included in a host group.

In other words, the SM copy detection system of FIG. 1 may manage, using at least one Access Point (AP) 130, at least one SM 110 included in at least one host group 120.

Additionally, the SM copy detection system of FIG. 1 may manage, using at least one MSO 140, the at least one SM 110 connected to the at least one AP 130.

The SM copy detection system of FIG. 1 may be designed and modified in various forms, based on a location of a host information management server 150 arranged in the SM copy detection system of FIG. 1.

For example, the host information management server 150 of the SM copy detection system of FIG. 1 may be independently connected to the at least one MSO 140, and may perform the authentication of the at least one SM 110.

Each of the at least one MSO 140 may be connected via a secure interface to the DHIM server 150, to perform final authentication of the SM 110 in the host group 120 connected to a network of the at least one MSO 140. Here, the DHIM server 150 may exist outside the at least one MSO 140.

Accordingly, according to an embodiment of the present invention, the MSO 140 may avoid load imposed by managing host information of the host group 120. Additionally, a subscriber that desires to receive a cable broadcasting service by moving the MSO 140 may only request the service without a need to separately register an apparatus in the host group 120 of the subscriber, so that the cable broadcasting service may be provided.

Each element of the SM copy detection system of FIG. 1 will be further described below.

The DHIM server 150 may be independent of the at least one MSO 140, and may be connected via the secure interface to the at least one AP 130 in each of the at least one MSO 140.

For example, as shown in FIG. 1, the DHIM server 150 may use, as a secure interface, TLS_RSA_WITH_AES_{—}256_CBC_SHA that is one of a Transport Layer Security (TLS) standard.

The at least one AP 130 and the DHIM server 150 may exchange with each other, factors for detecting copy of the SM 110. In other words, the at least one AP 130 may exchange, with the DHIM server 150, copy detection information regarding copy detection of the at least one SM 110.

Here, the copy detection information may include a variety of information, such as an ID of the at least one AP 130 (hereinafter, referred to as an ‘AP_ID’), an ID of the at least one SM 110 (hereinafter, referred to as an ‘SM_ID’), an ID of a TransPort (TP) mounted in the at least one host group 120 (hereinafter, referred to as an ‘TP_ID’), a version value for Conditional Access System (CAS) image information, a version value for hardware and software of the at least one SM 110, information regarding a validity of at least one of the AP_ID, the SM_ID, and the TP_ID, and download confirmation information for the CAS image information.

The DHIM server 150 may transfer authentication result information (hereinafter, referred to as ‘Auth_Rst’) to the at least one AP 130.

The at least one AP 130 may transfer, to the DHIM server 150, an authentication request message for the CAS image information (hereinafter, referred to as ‘CAS Image Download Confirm’). Here, the SM copy detection system of FIG. 1 may determine whether to transfer the ‘CAS Image Download Confirm’.

Hereinafter, the copy detection information will be further described.

The ‘AP_ID’ may be used as an ID value of each of the at least one AP 130 located in each of the at least one MSO 140, and may be a unique value in the at least one MSO 140.

The ‘SM_ID’ may be used as an ID value of each of the at least one SM 110 in each of the at least one host group 120, and may be a unique value in the at least one MSO 140.

The ‘TP_ID’ may be used as an ID value of each TP mounted in each of the at least one host group 120, and may be a unique value in the at least one MSO 140.

Version information (hereinafter, referred to as ‘VerInfo’) according to an embodiment of the present invention may have the version value for the CAS image information, and the version value for the hardware and software of the at least one SM 110.

The ‘Auth_Rst’ may represent validity of ID values transferred by the at least one AP 130 to the DHIM server 150. For example, when the ID values received from the at least one AP 130 are determined to be valid, the DHIM server 150 may set a value of the ‘Auth_Rst’ to be ‘success’. When the received ID values are determined to be invalid, the DHIM server 150 may set the value of the ‘Auth_Rst’ to be ‘failure’.

The ‘CAS Image Download Confirm’ may be transferred from the SM 110 to the AP 130 when the SM 110 downloads the CAS image information from a headend of the MSO 140 normally without errors.

Here, when the ‘CAS Image Download Confirm’ is received from the SM 110, the AP 130 may perform a relay operation to the DHIM server 150.

The SM copy detection system of FIG. 1 may include a database (DB) 160 to store the copy detection information, and state information of the at least one SM 110.

The DB 160 may be connected to the DHIM server 150, and may store the ‘AP_ID’, the ‘SM_ID’, the ‘TP_ID’, the state information of the at least one SM 110, the version value for the CAS image information, and the version value for the hardware and software of the at least one SM 110.

Here, the state information of the at least one SM 110 may be variously classified based on whether the at least one SM 110 is authenticated and whether the at least one SM 110 joins a DCAS service.

The state information of the at least one SM 110 may be classified into first state information indicating a state before a DCAS service is provided to the at least one SM 110, second state information indicating a state where the at least one SM 110 is included in at least one MSO 140 and joins the DCAS service, and third state information indicating a state where the at least one SM 110 is withdrawn from the DCAS service. Hereinafter, the state information will be further described.

The first state information may indicate a ‘Virgin’ state where the at least one SM 110 is mounted in the at least one host group 120 by a Set-Top Box (STB) manufacturer and is not provided with the DCAS service. In the ‘Virgin’ state, the CAS image information may not be contained in a memory of the SM 110.

Accordingly, the DHIM server 150 may manage the first state information of the SM 110 through the DB 160, so that the SM 110 may be in the ‘Virgin’ state.

The second state information may indicate an ‘Auth_Service’ state. When the SM 110 in the ‘Virgin’ state joins a DCAS service provided by a specific MSO 140 and accesses a network of the specific MSO 140, CAS image information may be downloaded from a headend of the specific MSO 140.

Here, when the SM 110 normally downloads the CAS image information to receive a fee-based service from the specific MSO 140, the DHIM server 150 may manage the state of the SM 110, so that the SM 110 may be in the ‘Auth_Service’ state.

The third state information may indicate an ‘Auth_Not_Service’ state. When the SM 110 in the ‘Auth_Service’ state is withdrawn from the DCAS service provided by the MSO 140, the DHIM server 150 may manage the state of the SM 110, so that the SM 110 may be in the ‘Auth_Not_Service’ state.

According to an embodiment of the present invention, only when the SM 110 is in the ‘Auth_Service’ state, the state of the SM 110 may be changed to the ‘Auth_Not_Service’ state. In other words, when the SM 110 is in the ‘Virgin’ state, the state of the SM 110 may not be changed directly to the ‘Auth_Not_Service’ state.

Additionally, the SM 110 in the ‘Auth_Not_Service’ state may not be changed to be in the ‘Virgin’ state. Specifically, when the SM 110 is withdrawn from the service of an MSO 140 and rejoins the service, or joins a service of another MSO 140, the state of the SM 110 may be changed from the ‘Auth_Not_Service’ state to the ‘Auth_Service’ state, and may be managed by the DHIM server 150.

The at least one MSO 140 may respectively correspond to cable broadcasting operators.

The at least one AP 130 may be located in the headend of the at least one MSO 140, and may function to authenticate a host of each of the at least one host group 120. Accordingly, the at least one AP 130 may be connected via the secure interface to the DHIM server 150 in addition to the host of each of the at least one host group 120.

The at least one AP 130 may sort out messages to be transferred to the DHIM server 150, from among messages received from the at least one SM 110, and may transfer the sorted messages to the DHIM server 150.

When the DHIM server 150 succeeds to authenticate the SM 110, the AP 130 may operate together with the SM 110 an encryption key sharing protocol for encryption of the CAS image information, and may transfer a shared encryption key to a headend image download server of the at least one MSO 140, so that the encryption key may be used to encrypt the CAS image information.

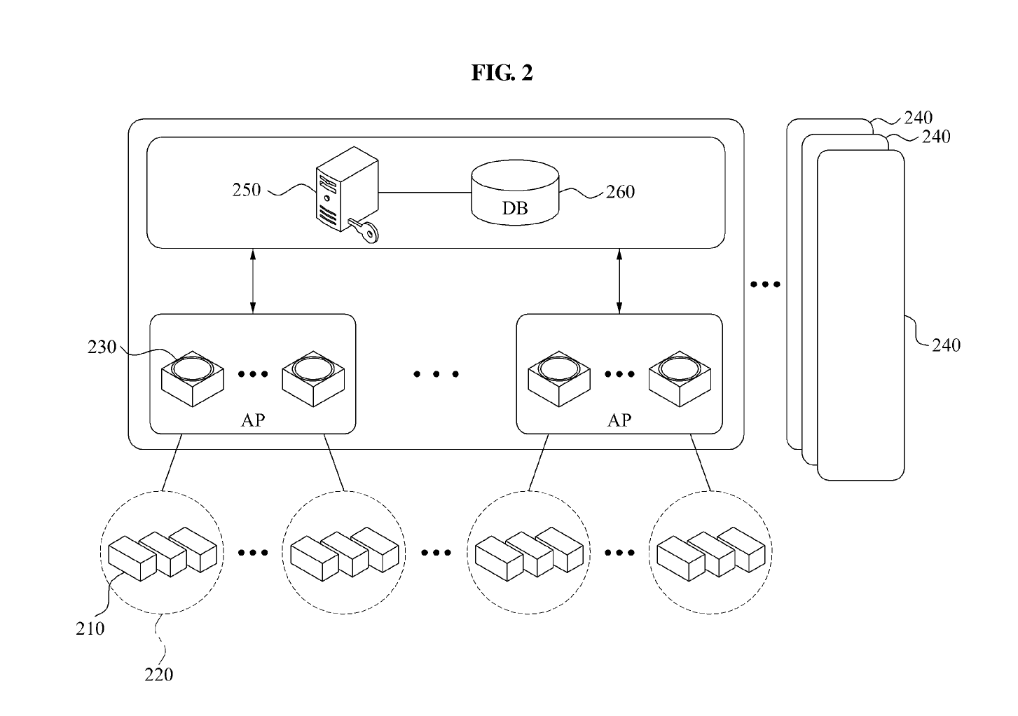

Hereinafter, an SM copy detection system according to another embodiment of the present invention will be described with reference to FIG. 2.

FIG. 2 is a block diagram illustrating a configuration of an SM copy detection system according to another embodiment of the present invention.

As shown in FIG. 2, the SM copy detection system may include at least one AP 230, at least one MSO 240, and a DHIM server 250. The at least one AP 230 may be connected to at least one host group 220 including at least one SM 210. The at least one MSO 240 may include the at least one AP 230, and may manage the at least one SM 210. The DHIM server 250 may be dependent on the at least one MSO 240, and may perform authentication of the at least one SM 210.

In other words, in the SM copy detection system of FIG. 2, the DHIM server 250 may be included in the at least one MSO 240, rather than being independent of the at least one MSO 240.

Accordingly, the SM copy detection system of FIG. 2 may be applied to only host groups 220 in the at least one MSO 240.

Here, a host group moved from different MSOs among the at least one host group 220 may perform authentication and registration through the DHIM server 250.

In other words, to provide the moved host group with a service, there may be a need to register the moved host group in the DHIM server 250 operated by the MSO 240 to which the host group is to move.

The SM copy detection system of FIG. 2 may also include a DB 260 to provide and store a variety of information.

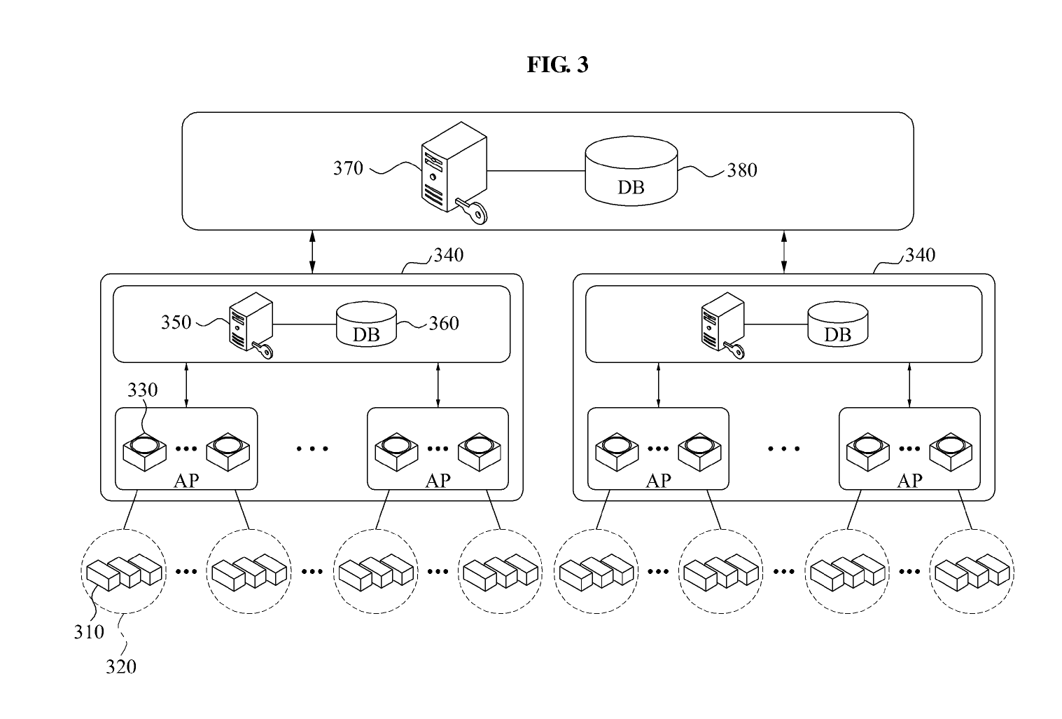

Hereinafter, an SM copy detection system according to still another embodiment of the present invention will be described with reference to FIG. 3.

FIG. 3 is a block diagram illustrating a configuration of an SM copy detection system according to still another embodiment of the present invention.

As shown in FIG. 3, the SM copy detection system may include at least one AP 330, at least one MSO 340, a first host information management server 350, and a second host information management server 370. The at least one AP 330 may be connected to at least one host group 320 including at least one SM 310. The at least one MSO 340 may include the at least one AP 330, and may manage the at least one SM 310. The first host information management server 350 may be dependent on the at least one MSO 340, and may perform authentication of the at least one SM 310, and the second host information management server 370 may be independently connected to the at least one MSO 340, and may perform authentication of the at least one SM 310.

In other words, the SM copy detection system of FIG. 3 may be advantageously used when a host group for lease and a host group for retail are operated together.

The at least one MSO 340 may enable the first host information management server 350 to perform authentication of an SM in the host group for lease.

Additionally, the SM copy detection system of FIG. 3 may enable the second host information management server 370 independent of the at least one MSO 340 to perform authentication of an SM in a host group purchased directly by a subscriber in a retail market.

The SM copy detection system of FIG. 3 may enable a subscriber possessing a host group for retail to receive a cable broadcasting service, when the subscriber only joins the cable broadcasting service online or offline without performing a separate apparatus registration process even when the at least one MSO 340 is moved.

The SM copy detection system of FIG. 3 may also include DBs 360 and 380 to provide and store a variety of information.

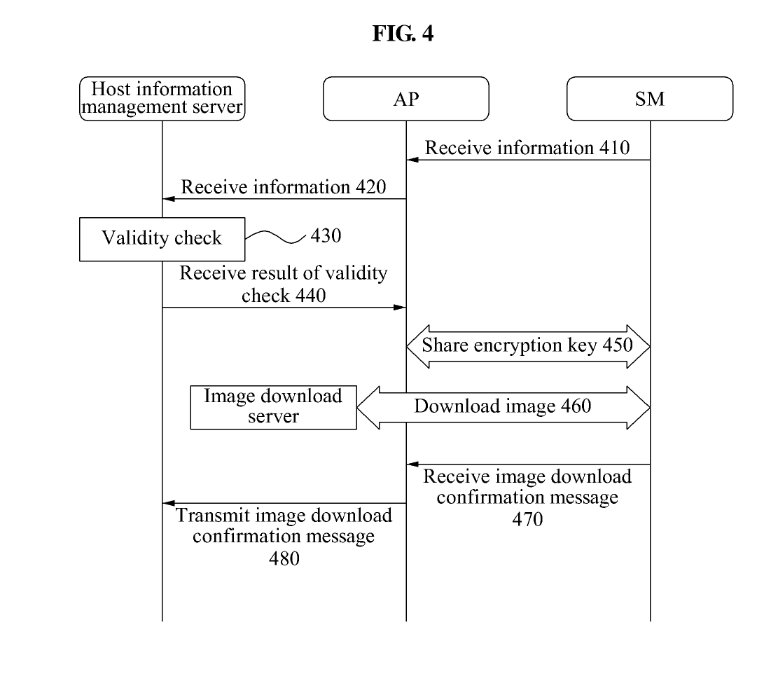

Hereinafter, a host copy detection method according to an embodiment of the present invention will be described with reference to FIGS. 4 through 6.

FIG. 4 is a flowchart illustrating an SM copy detection method according to an embodiment of the present invention.

In operation 410, an AP of an SM copy detection system according to an embodiment of the present invention may receive, from an SM, first ID information regarding an ID of the SM.

In operation 420, the AP may transmit, to a host information management server, the first ID information, second ID information regarding an ID of the AP, and ‘VerInfo’ of the SM.

Here, the first ID information may include an ‘SM_ID’, and a ‘TP_ID’, and the second ID information may include an ‘AP_ID’.

Additionally, the ‘VerInfo’ may have a version value for CAS image information, and a version value for hardware and software of the SM.

The host information management server may perform a validity check of the SM, based on the AP_ID, the SM_ID, the TP_ID, and the VerInfo that are received from the AP.

First, the host information management server may perform an ID validity check operation, that is, may determine whether the AP_ID, the SM_ID, and the TP_ID exist in a DB. When all of the AP_ID, the SM_ID, and the TP_ID are determined to exist in the DB, the host information management server may determine the ID validity check operation to succeed. When no the AP_ID, the SM_ID, and the TP_ID are determined to exist in the DB, the host information management server may determine the ID validity check operation to fail.

In operation 430, the host information management server may perform an SM state validity check operation, that is, may determine whether an authentication request is received from an SM having state information indicating a normal state, and may then determine that the SM state validity check operation succeeds only when an authentication request is received from an SM in the ‘Virgin’ state or the ‘Auth_Not_Service’ state.

Additionally, in the case an authentication request is received from an SM in the ‘Auth_Service’ state, only when a ‘VerInfo validity check’ operation is determined to succeed, the host information management server may permit authentication of the SM. Here, the ‘VerInfo validity check’ operation will be described below.

Subsequently, the host information management server may perform the VerInfo validity check operation, that is, may permit the authentication of the SM, when the authentication request is performed by updating CAS image information, despite the authentication request being received from the SM in the ‘Auth_Service’ state.

In other words, when a CAS image is determined to need to be updated, an MSO according to an embodiment of the present invention may reconfirm the authentication of the SM, prior to transferring updated CAS image information to the SM.

To perform the above operation 430, the AP may request the host information management server to authenticate an SM.

Here, when state information of an SM that is being managed by the host information management server indicates the ‘Auth_Service’ state, and when an authentication request is received from the SM, the host information management server may determine that the authentication request is received from a copied SM, and may reject authentication of the SM. However, when a version of the CAS image information is updated, despite the authentication request being received from the SM in the ‘Auth_Service’ state, the host information management server may permit the authentication of the SM.

When the validity check of the SM is completed, the host information management server may transfer a result of the validity check to the AP through the ‘Auth_Rst’. Here, when the authentication of the SM succeeds, a value of the ‘Auth_Rst’ may be set as ‘success’. Conversely, when the authentication of the SM fails, the value of the ‘Auth_Rst’ may be set as ‘failure’.

In operation 440, the AP may receive the result of the validity check of the SM that is performed based on the first ID information, the second ID information, and the ‘VerInfo’.

The result of the validity check may include a result value of a validity check of the SM_ID, a validity check result value for the state information of the SM, and a validity check result value for the ‘VerInfo’. Here, the validity check of the SM_ID may be performed based on the first ID information and the second ID information.

The state information of the SM may include first state information indicating a state before a DCAS service is provided to the SM, second state information indicating a state where the SM is included in at least one MSO and joins the DCAS service, and third state information indicating a state where the SM is withdrawn from the DCAS service.

Thus, the AP in the SM copy detection system may authenticate the SM based on the result of the validity check.

Here, when an authentication request for the SM is received when the state of the SM corresponds to the first state information and the third state information, the SM copy detection system may authenticate the SM.

Additionally, when the validity check result value for the ‘VerInfo’ is updated and when an authentication request for the SM is received when a state of the SM corresponds to the second state information, the SM copy detection system may authenticate the SM.

For example, when the value of the ‘Auth_Rst’ is set as ‘success’, the AP may perform the encryption key sharing protocol together with the SM. As described above, the encryption key may be used to encrypt the CAS image information.

In operation 450, the AP may share the encryption key with the authenticated SM.

In operation 460, the AP may transmit the encryption key to an image download server, and may permit the CAS image information to be downloaded in the SM.

Specifically, when an encryption key for CAS image information is successfully generated, the AP may transfer the generated encryption key to a headend CAS image download server of the MSO.

The CAS image download server may encrypt the CAS image information using the encryption key received from the AP, and may transfer the encrypted CAS image information to the SM using various schemes.

In operation 470, the AP may receive an image download confirmation message from the SM that downloads the CAS image information.

In operation 480, the AP may transmit the image download confirmation message to the host information management server.

Operation 480 may be performed to prevent the host information management server from rejecting authentication of an SM when the SM is restarted from a protocol initialization process due to errors occurring during use of the protocol between the SM and the AP.

When a re-authentication request is received from the SM in the ‘Auth_Service’ state, the host information management server may determine the SM as a copied SM, and may transfer an authentication failure message to the AP.

As a result, in the SM copy detection system, even a normal SM may not download CAS image information.

Accordingly, to prevent the errors, the SM copy detection system may repeatedly permit an authentication request from an SM within a number of times the SM is authenticated, until the host information management server receives the ‘CAS Image Download Confirm’ from the AP. Here, the number of times may be determined in advance by an operator.

Additionally, when the AP has a function of reusing an SM authentication result received from the host information management server, instead of deleting the SM authentication result, until the SM receives the ‘CAS Image Download Confirm’, the SM copy detection system may not perform the above operation 480.

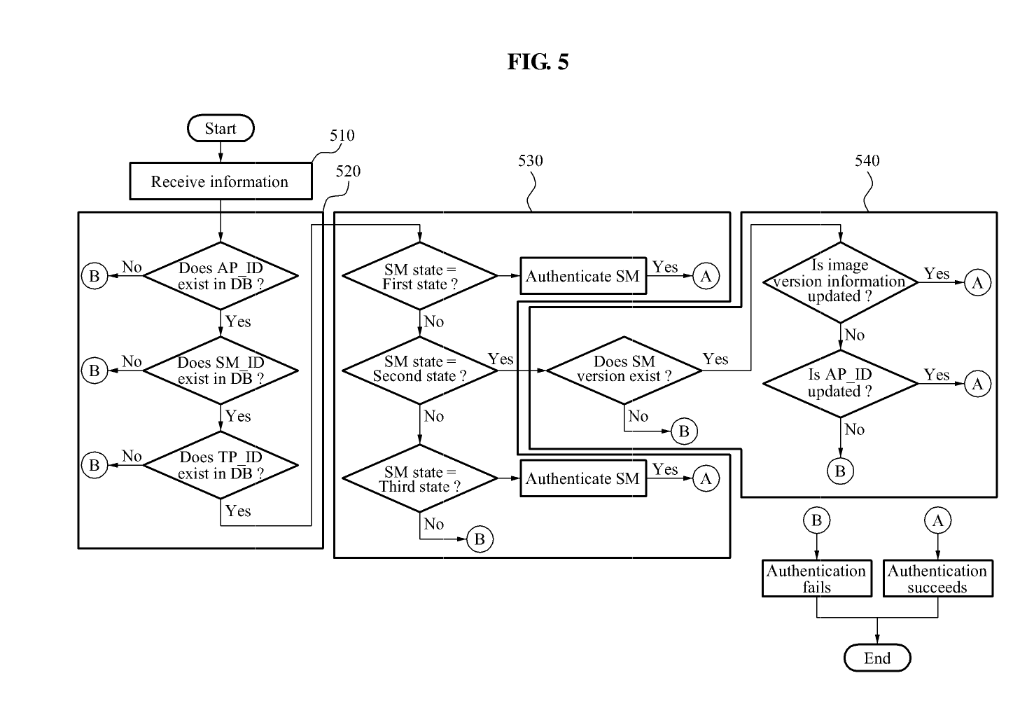

FIG. 5 is a flowchart illustrating an SM copy detection method using a host information management server according to an embodiment of the present invention.

The SM copy detection method of FIG. 5 may be performed when a ‘CAS Image Download Confirm’ is not received from an AP.

In other words, when the AP has a function of reusing an SM authentication result received from the host information management server, instead of deleting the SM authentication result, until an SM receives the ‘CAS Image Download Confirm’, the SM copy detection method of FIG. 5 may be performed.

The SM copy detection method of FIG. 5 may broadly include an ‘ID validity check operation’, an ‘SM state validity check operation’, and a ‘VerInfo validity check operation’.

In operation 510, the host information management server may receive, from at least one AP, first ID information regarding an ID of at least one SM, second ID information regarding an ID of the at least one AP, and version information of the at least one SM.

In operation 520, the host information management server may perform a first check operation of checking a validity of the at least one SM based on the first ID information and the second ID information.

Specifically, the host information management server may determine whether an AP_ID, an SM_ID, and a TP_ID that are received from the at least one AP exist in a DB. When the AP_ID, the SM_ID, and the TP_ID are determined not to exist in the DB, the host information management server may determine the value of the ‘Auth_Rst’ to be ‘failure’.

In operation 530, the host information management server may perform a second check operation of checking the validity of the at least one SM based on state information of the at least one SM. Here, the state information of the at least one SM may be received from the at least one AP.

Additionally, the state information of the at least one SM may include first state information indicating a state before a DCAS service is provided to the at least one SM, second state information indicating a state where the at least one SM is included in at least one MSO and joins the DCAS service, and third state information indicating a state where the at least one SM is withdrawn from the DCAS service.

Specifically, when an authentication request is received from an SM in a ‘Virgin’ state, the host information management server may change the ‘Virgin’ state of the SM to an ‘Auth_Service’, and may set the value of the ‘Auth_Rst’ to be ‘success’.

When an authentication request is received from an SM in the ‘Auth_Service’ state, the host information management server may perform a third check operation.

Furthermore, when an authentication request is received from an SM in an ‘Auth_Not_Service’ state, the host information management server may change the ‘Auth_Not_Service’ state of the SM to the ‘Auth_Service’ state, and may set the value of the ‘Auth_Rst’ to be ‘success’.

In operation 540, the host information management server may perform the third check operation of checking the validity of the at least one SM based on the version information.

Here, the host information management server may perform the third check operation, only when an SM requesting authentication is in the ‘Auth_Service’ state.

First, the host information management server may download, in the DB, hardware and software version information corresponding to an ID value of the SM that requests authentication.

Subsequently, the host information management server may determine whether the hardware and software version information called from the DB is identical to hardware and software version information for the SM received from the at least one AP.

When the called hardware and software version information is determined to be identical to the received hardware and software version information, the host information management server may proceed to a next operation. Conversely, when the called hardware and software version information is determined to differ from the received hardware and software version information, the host information management server may set the value of the ‘Auth_Rst’ to be ‘failure’.

Additionally, the host information management server may determine whether CAS image version information is updated, only when the received hardware and software version information is determined to be identical to the hardware and software version information stored in the DB.

Here, the updated CAS image version information may indicate that CAS image version information stored, in advance, in the DB differs from version information newly received from the AP.

When determining that the CAS image version information is not updated, the host information management server may determine whether an AP_ID value is changed.

Specifically, the host information management server may determine whether an AP_ID received from the AP differs from an AP_ID that is stored in the DB and is used to identify an AP including a corresponding SM.

The host information management server may determine whether the AP_ID value is changed, to permit authentication of a normal SM when the normal SM moves on an AP zone, despite the CAS image version information being updated.

Finally, the host information management server may authenticate the at least one SM, based on a result of at least one of the first check operation, the second check operation, and the third check operation.

Here, when the state of the at least one SM corresponds to the first state information and the third state information in the second check operation, the host information management server may authenticate the at least one SM.

Additionally, when a validity check result value for the ‘VerInfo’ is updated and when the state of the at least one SM corresponds to the second state information, the host information management server may authenticate the at least one SM.

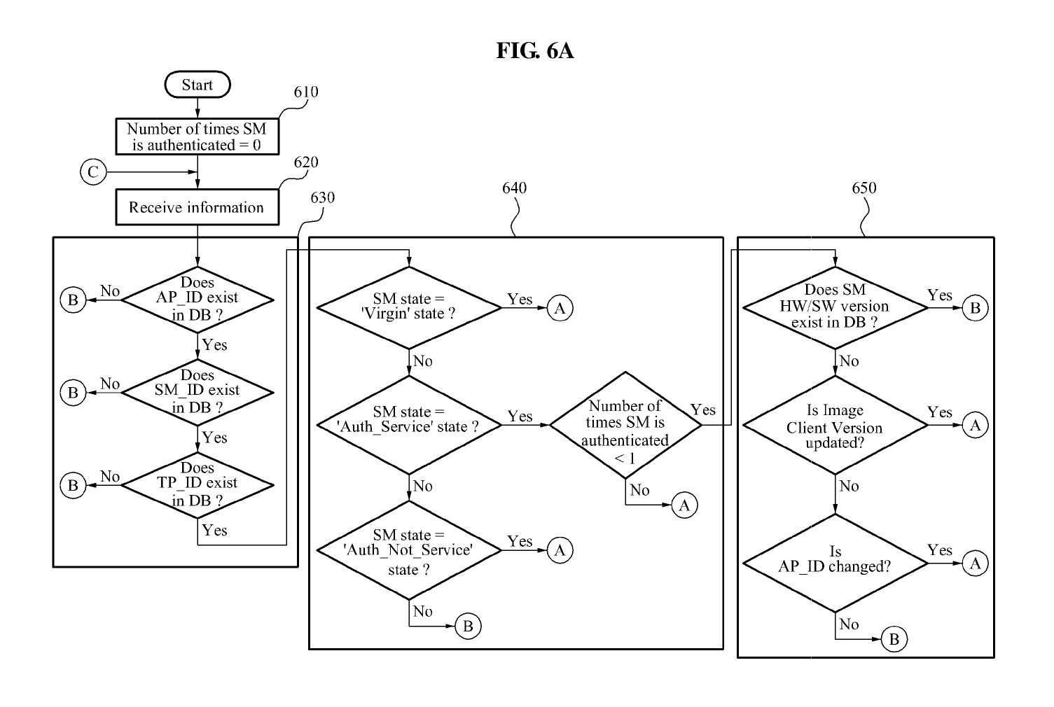

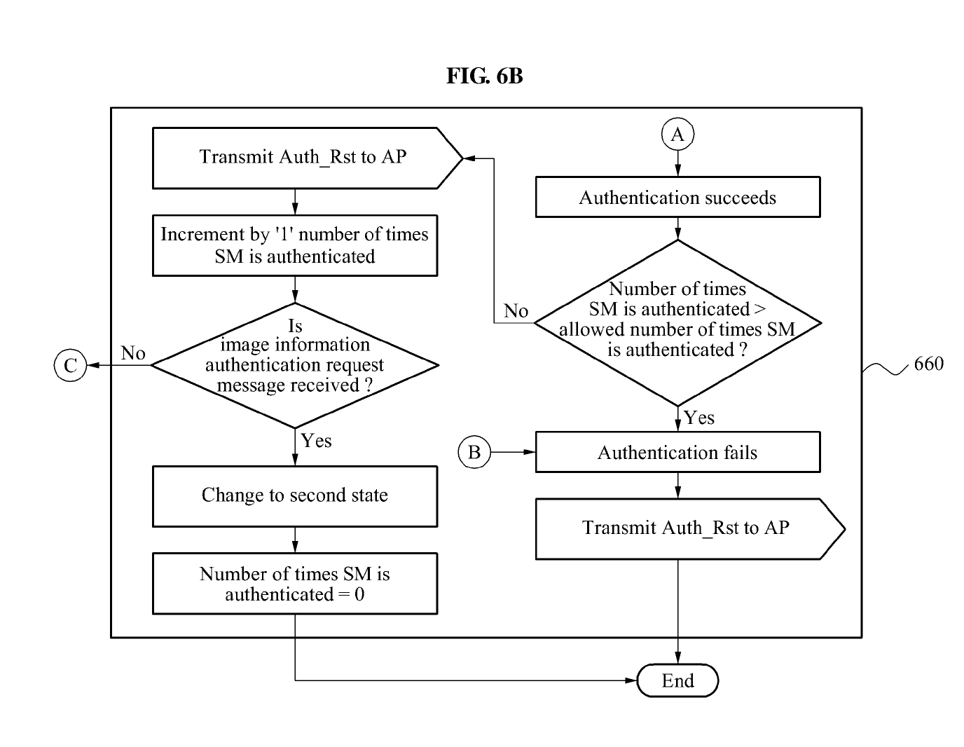

FIGS. 6A and 6B are flowcharts illustrating an SM copy detection method using a host information management server according to another embodiment of the present invention.

In an SM copy detection system according to an embodiment of the present invention, the second check operation may be performed, that is, the validity of the at least one SM may be repeatedly checked the same number of times as a predetermined number of times that the at least one SM is authenticated, when the ‘CAS Image Download Confirm’ is received from the at least one AP, except when a ‘CAS Image Download Confirm’ is received from the at least one SM.

In other words, the SM copy detection method of FIGS. 6A and 6B may be performed when the AP does not have a function of reusing an SM authentication result received from the host information management server instead of deleting the SM authentication result, until the SM receives the ‘CAS Image Download Confirm’.

In operation 610, the host information management server may initialize a number of times that an SM is authenticated.

In operation 620, the host information management server may receive, from at least one AP, first ID information regarding an ID of at least one SM, second ID information regarding an ID of the at least one AP, version information of the at least one SM, as described above.

First check operation 630 of FIG. 6A may be performed in the same manner as first check operation 520 of FIG. 5.

Second check operation 640 of FIG. 6A may be performed in the same manner as second check operation 530 of FIG. 5, except for checking of the number of times that the at least one SM is authenticated.

When the number of times the SM is authenticated is less than ‘1’, the host information management server may perform third check operation 650. Otherwise, the host information management server may perform fourth check operation 660 of repeatedly checking whether SM authentication is permitted.

Here, third check operation 650 of FIG. 6A may be performed in the same manner as third check operation 540 of FIG. 5.

Operation 660 of FIG. 6B may be performed so that the host information management server may repeatedly permit an authentication request from an identical SM within a number of times the identical SM is authenticated, until the ‘CAS Image Download Confirm’ is received from the AP. Here, the number of times may be determined in advance by an operator.

According to embodiments of the present invention, it is possible to detect information regarding a copy of an SM in a DCAS.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A Secure Micro (SM) copy detection method, comprising:
receiving first identifier (ID) information from at least one SM, the first ID information regarding an ID of the at least one SM;
transmitting, to a host information management server, the first ID information, second ID information regarding an ID of at least one Access Point (AP), and version information of the at least one SM;
receiving a result of a validity check of the at least one SM, the validity check being performed based on the first ID information, the second ID information, and the version information; and
authenticating the at least one SM based on the received result.

2. The SM copy detection method of claim 1, further comprising:
sharing an encryption key with the authenticated SM, the encryption key being used to encrypt Conditional Access System (CAS) image information;
transmitting the encryption key to an image download server and permitting the CAS image information to be downloaded in the at least one SM;
receiving an image download confirmation message from the at least one SM downloading the CAS image information; and
transmitting the image download confirmation message to the host information management server.

3. The SM copy detection method of claim 1, wherein the result comprises:
a result value of a validity check of an ID of the at least one SM, the validity check being performed based on the first ID information and the second ID information;
a validity check result value for state information of the at least one SM; and
a validity check result value for the version information.

4. The SM copy detection method of claim 3, wherein the state information of the at least one SM comprises:
first state information indicating a state before a Downloadable Conditional Access System (DCAS) service is provided to the at least one SM;
second state information indicating a state where the at least one SM is comprised in at least one Multiple-Services Operator (MSO) and joins the DCAS service; and
third state information indicating a state where the at least one SM is withdrawn from the DCAS service.

5. The SM copy detection method of claim 4, wherein the authenticating comprises authenticating the at least one SM when an authentication request for the at least one SM is received when a state of the at least one SM corresponds to the first state information and the third state information.

6. The SM copy detection method of claim 4, wherein the authenticating comprises authenticating the at least one SM when the validity check result value for the version information is updated and when an authentication request for the at least one SM is received when a state of the at least one SM corresponds to the second state information.

7. An SM copy detection method, comprising:
receiving, from at least one AP, first ID information regarding an ID of at least one SM, second ID information regarding an ID of the at least one AP, and version information of the at least one SM;
first checking a validity of the at least one SM based on the first ID information and the second ID information;
second checking the validity of the at least one SM based on state information of the at least one SM, the state information being received from the at least one AP;
third checking the validity of the at least one SM based on the version information; and
authenticating the at least one SM based on a result of at least one of the first checking, the second checking, and the third checking.

8. The SM copy detection method of claim 7, wherein the state information of the at least one SM comprises:
first state information indicating a state before a DCAS service is provided to the at least one SM;
second state information indicating a state where the at least one SM is comprised in at least one MSO and joins the DCAS service; and
third state information indicating a state where the at least one SM is withdrawn from the DCAS service.

9. The SM copy detection method of claim 8, wherein the authenticating comprises authenticating the at least one SM when a state of the at least one SM corresponds to the first state information and the third state information in the second checking.

10. The SM copy detection method of claim 8, wherein the authenticating comprises authenticating the at least one SM when a validity check result value for the version information is updated and when a state of the at least one SM corresponds to the second state information.

11. The SM copy detection method of claim 7, wherein the second checking comprises repeatedly checking the validity of the at least one SM the same number of times as a predetermined number of times that the at least one SM is authenticated, except when an authentication request message for CAS image information is received from the at least one SM.

12. An SM copy detection system, comprising:
at least one AP connected to at least one host group comprising at least one SM;
at least one MSO to manage the at least one SM, the MSO comprising the at least one AP; and
a host information management server to perform authentication of the at least one SM, the host information management server being independently connected to the at least one MSO.

13. The SM copy detection system of claim 12, wherein the at least one AP is connected to the at least one host group and the host information management server through a secure interface.

14. The SM copy detection system of claim 12, wherein the at least one AP exchanges information regarding a copy detection of the at least one SM, with the host information management server.

15. The SM copy detection system of claim 14, wherein the information regarding the copy detection comprises:
an AP_ID of the at least one AP;
an SM_ID of the at least one SM;
a TP_ID of a TransPort (TP) mounted in the host group;
a version value for CAS image information;
a version value for hardware and software of the at least one SM:
information regarding a validity of at least one of the AP_ID, the SM_ID, and the TP_ID; and
download confirmation information for the CAS image information.

16. The SM copy detection system of claim 15, further comprising:
a database (DB) to store the information regarding the copy detection and state information of the at least one SM.

17. The SM copy detection system of claim 16, wherein the state information of the at least one SM comprises:
first state information indicating a state before a DCAS service is provided to the at least one SM;
second state information indicating a state where the at least one SM is comprised in at least one MSO and joins the DCAS service; and
third state information indicating a state where the at least one SM is withdrawn from the DCAS service.

18. An SM copy detection system, comprising:
at least one AP connected to at least one host group comprising at least one SM;
at least one MSO to manage the at least one SM, the MSO comprising the at least one AP; and
a host information management server to perform authentication of the at least one SM, the host information management server being dependent on the at least one MSO.

19. The SM copy detection system of claim 18, wherein a host group moved from different MSOs among the at least one host group performs authentication and registration through the host information management server.

20. An SM copy detection system, comprising:
at least one AP connected to at least one host group comprising at least one SM;
at least one MSO to manage the at least one SM, the MSO comprising the at least one AP;
a first host information management server to perform authentication of the at least one SM, the first host information management server being dependent on the at least one MSO; and
a second host information management server to perform authentication of the at least one SM, the second host information management server being independently connected to the at least one MSO.
